(19) United States
(12) Patent Application Publication
(10) Pub. No.: US 2010/0006053 A1
(43) Pub. Date: Jan. 14, 2010

(54) AIR-INTAKE DEVICE HAVING PLURAL VALVES FOR INTERNAL COMBUSTION ENGINE

(75) Inventor: Makoto KONDO, Nishikamo-gun (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/489,713

(22) Filed: Jun. 23, 2009

(30) Foreign Application Priority Data
Jul. 14, 2008 (JP) 2008-182356

(51) Int. Cl. F02M 35/10

(52) U.S. Cl. 123/184.56

(57) ABSTRACT

An air-intake device of the present invention includes a casing having plural air passages each connected to an intake port of each cylinder of an internal combustion engine. A valve for controlling amount of intake air is disposed in each air passage of the casing. All the valves are connected to a common shaft that is driven by an actuator under control of an on-board electronic control unit. At least one end of the shaft is supported in a bearing-supporting portion formed in the casing via a bearing device composed of a sleeve bearing and a resilient rubber bushing. The sleeve bearing is rotatably coupled to the shaft end, and the rubber bushing is compressed between an inner bore of the bearing-supporting portion and the sleeve bearing. A clearance change between the sleeve bearing and the inner bore of the bearing-supporting portion due to changes in temperature is absorbed by resiliency of the rubber bushing, securing smooth rotation of the shaft.

### CROSS-REFERENCE TO RELATED APPLICATION

This application is based upon and claims benefit of priority of Japanese Patent Application No. 2008-182356 filed on Jul. 14, 2006, the content of which is incorporated herein by reference.

### BACKGROUND OF THE INVENTION

1. Field of the Invention

The present invention relates to an air-intake device having plural air passages each connected to each cylinder of an internal combustion engine. A valve for controlling amount of air supplied to the engine is disposed in each air passage of the air-intake device. The valve in the air passage is controlled to generate a swirl flow in the air passage.

2. Description of Related Art

Air-intake devices for an internal combustion engine having plural valves, each provided for controlling an amount of air supplied to each cylinder of the engine, are disclosed in JP-A-2007-170340 and JP-A-2008-45430. An essential structure of the air-intake device and a structure relevant to the present invention are shown in FIGS. 7-10 attached hereto.

As shown in FIGS. 7-10, a casing 101 forming an intake manifold includes plural air passages 111, 112, each connected to each intake port 113 of a cylinder head 102. A cartridge 103 having a valve 104 disposed in each air passage 112 is disposed in a space 114 for accommodating the cartridge 103. A shaft 105 is press-fitted into a through hole 106 formed through all of the valves 104 so that an opening degree of all valves is simultaneously controlled by rotating the shaft 105.

The shaft 105 is rotatably supported in the casing 101 at its both axial ends. A bearing-supporting portion 116 is formed on the casing 101 for supporting an axial end 115 (a right side end in FIG. 7) of the shaft 105. A joint-shaft 107 is connected to a left end of the shaft 105 and is rotatably supported via a ball bearing 108 in a bearing-supporting portion 117 formed on the casing 101. The casing 101 forming the intake manifold is made of a synthetic resin material, and the shaft 105 is made of a metallic material.

As shown in FIG. 10, the end portion 115 of the shaft 105 is directly supported in the bearing-supporting portion 116. A small clearance is made between the end portion 115 and an inner bore of the bearing-supporting portion 116 to ascertain smooth rotation of the shaft 105 and to facilitate easy assembly of the shaft 105 with the casing 101.

However, there is a possibility in the conventional air-intake device that the clearance between the end portion 115 of the shaft 105 and the inner bore of the bearing-supporting portion 116 varies according to temperature. If the clearance is enlarged, the end portion 115 moves in the inner bore of the bearing-supporting portion 116 by intake air pulsation imposed on the valve plates 104. Thus, the end portion 115 hits the inner bore of the bearing-supporting portion 116, generating hitting noises. If the clearance is decreased, smooth rotation of the shaft 105 is hindered, adversely affecting a control of the opening degree of the valves 104.

It is impossible to completely eliminate dimensional deviations of components of the air-intake device in manufacturing processes. The shaft 105 may be supported in the casing 101 in a slanted manner due to dimensional deviations, resulting in a decrease in the clearance in the inner bore of the bearing-supporting portion 116. If this occurs, the assembling operation of the shaft 105 with the casing 101 becomes difficult.

### SUMMARY OF THE INVENTION

The present invention has been made in view of the above-mentioned problem, and an object of the present invention is to provide an improved air-intake device, in which a shaft connected to plural valves is smoothly rotated, hitting noises of the shaft caused by intake air pulsation are suppressed, and the shaft is easily assembled to a casing.

The air-intake device according to the present invention includes a casing having plural air passages each connected to an intake port of each cylinder, valves for controlling an amount of intake air to be supplied to an internal combustion engine, a shaft connected commonly to all valves for controlling an opening degree of the valves, and an actuator for driving the shaft under a control of an on-board electronic control unit. Each valve is held in a cartridge which is supported in each air passage of the casing. The shaft is connected to one end portion of each valve (valve plate) so that the valve pivotally moves around the shaft.

Both axial ends of the shaft are supported in bearing-supporting portions formed in the casing via bearing devices. At least one end of the shaft is supported via a bearing device composed of a bearing (sleeve bearing) rotatably coupled to the shaft end a rubber bushing disposed between an inner bore of the bearing supporting portion and an outer periphery of the bearing. The rubber bushing may be connected to the outer periphery of the bearing by baking or the like. Projected portions are formed on the outer surface of the rubber bushing, and the projected portions closely contact the inner bore of the bearing-supporting portion and is compressed between the inner bore of the bearing supporting portion and the bearing.

The projected portions may be formed as plural discrete circular ribs or a single spiral rib surrounding the outer periphery of the rubber bushing. Alternatively, the projected portions may be formed as plural projected ribs projected in the radial direction and elongated in the axial direction of the rubber bushing.

Since the rubber bushing having the projected portions resiliently supports the bearing and the shaft end in the bearing-supporting portion, a certain eccentricity of the shaft relative to the bearing-supporting portion is absorbed, making easier an assembling process of the shaft to the casing. Since a clearance increase or decrease between the inner bore of the bearing-supporting portion and the bearing due to temperature changes is absorbed by the resilient rubber bushing, smooth rotation of the shaft is ascertained. Further, hitting noises between the shaft end and the inner bore of the bearing-supporting portion caused by pulsating pressure imposed on the valves are suppressed.

Other objects and features of the present invention will become more readily apparent from a better understanding of the preferred embodiments described below with reference to the following drawings.

### BRIEF DESCRIPTION OF DRAWINGS

FIG. 1 is a cross-sectional view showing an air-intake device as a first embodiment of the present invention;

FIG. 2 is a cross-sectional view showing a cartridge having a valve used in the air-intake device shown in FIG. 1;

FIG. 3 is a perspective view showing the cartridge shown in FIG. 2;

FIG. 4 is a cross-sectional view showing a bearing device supported in a bearing-supporting portion of a casing;

FIG. 5 is a cross-sectional view showing a bearing device supported in a bearing-supporting portion of a casing, as a second embodiment of the present invention;

FIG. 6A is a cross-sectional view showing a bearing device supported in a bearing-supporting portion of a casing, as a third embodiment of the present invention;

FIG. 6B is a cross-sectional view showing the bearing device, taken along line VIB-VIB shown in FIG. 6A;

FIG. 7 is a cross-sectional view showing a conventional air-intake device;

FIG. 8 is a cross-sectional view showing a cartridge having a valve plate used in the air-intake device shown in FIG. 7;

FIG. 9 is a perspective view showing the cartridge shown in FIG. 8; and

FIG. 10 is a cross-sectional view showing an end portion of a shaft supported in a bearing-supporting portion in the conventional device shown in FIG. 7.

### DETAILED DESCRIPTION OF PREFERRED EMBODIMENTS

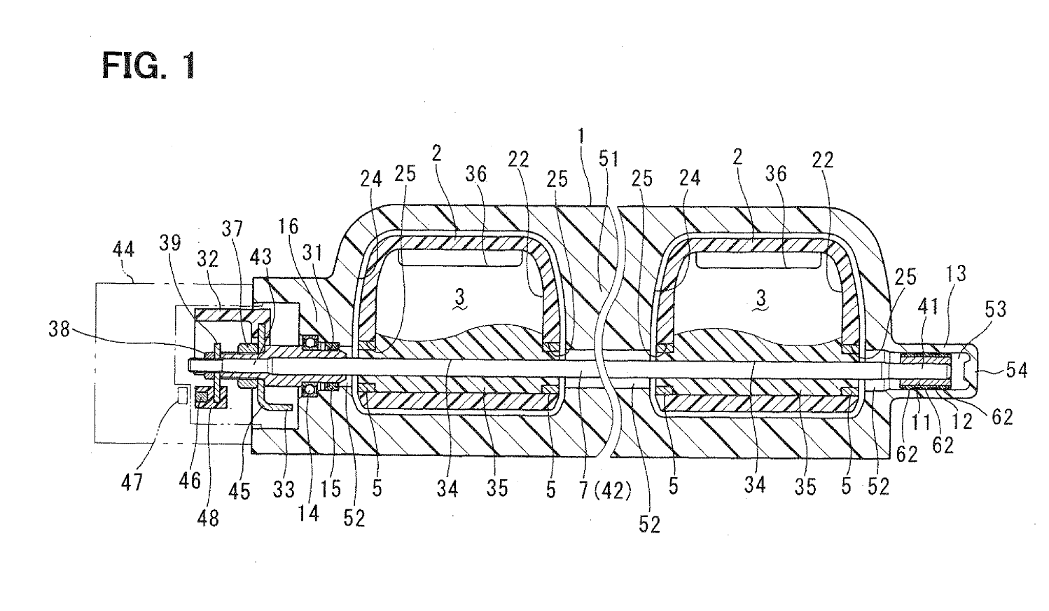

A first embodiment of the present invention will be described with reference to FIGS. 1-4. An air-intake device of the present invention includes plural air passages, each connected to each cylinder of an internal combustion engine. The air-intake device used in an in-line four-cylinder engine for an automotive vehicle will be described as an example. Air is introduced into cylinders of the engine through an air cleaner, an air-intake device which is electronically controlled, and a cylinder head of the engine. Swirl flows of intake air along the flow passage (such as circular flows or tumble flows) are generated by operation of the valve plates in the air-intake device.

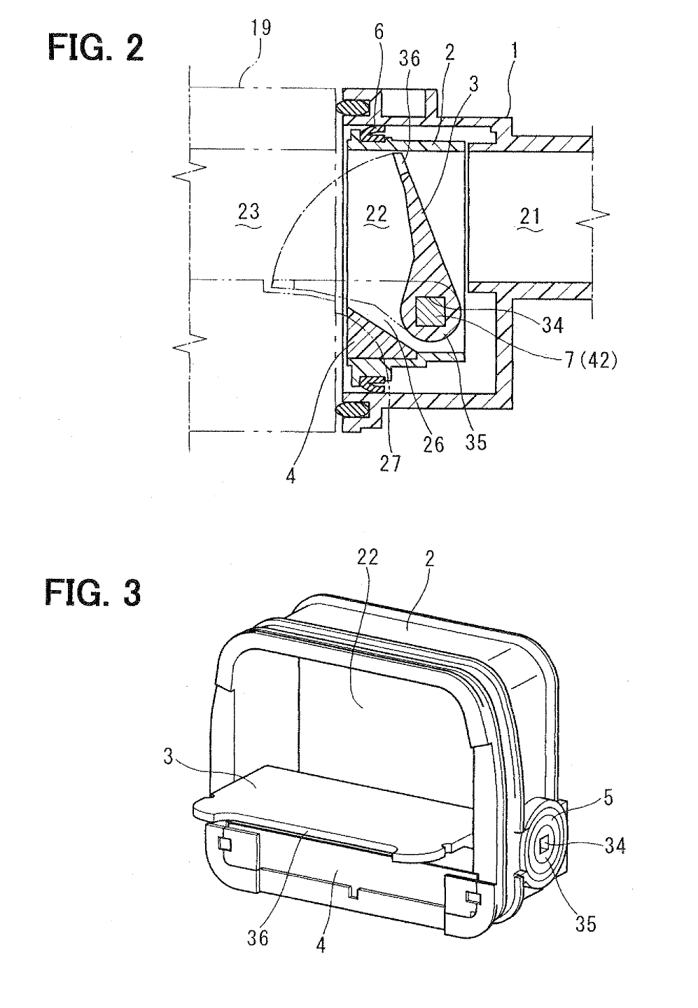

As shown in FIG. 1, plural valve units are disposed in a casing 1 forming an intake manifold. In this particular embodiment, four valve units, each corresponding to each cylinder, are disposed in the casing 1. As shown in FIG. 3, the valve unit is composed of a rectangular cartridge 2, a valve 3 movably supported in the cartridge 2, and spacer 4 disposed in the cartridge 2. As shown in FIG. 1, round through-holes 25 for supporting a valve axis 35 via bearings 5 are formed in sidewalls of each cartridge 2. Each cartridge 2 is supported in the casing 1 via a resilient gasket 6 (FIG. 2). The resilient gasket 6 absorbs changes in a clearance between the shaft and supporting bearings due to temperature changes. The cartridge 2 is supported in the casing 2 in a manner, a so-called floating gasket structure.

The shaft 7 connected to the valve axis 35 of each valve 3 has an end portion 41 (right side in FIG. 1), another end portion 43 (left side in FIG. 1) and a middle portion (42) between both end portions. Both end portions have a round cross-section while the middle portion (42) has a square cross-section connected to a through-hole 34 of the valve 3. The square cross-section may be modified to other polygonal cross-sections. The end portion 41 of the shaft 7 is rotatably supported in a bearing-supporting portion 13 of the casing 1 via a bearing 11 and a rubber bushing 12. The other end portion 43 of the shaft 7 is connected to a joint-shaft 31 which is rotatably supported in a bearing-supporting portion 16 of the casing 1 via an oil seal 15 and a ball bearing 14.

The internal combustion engine to which the air-intake device of the present invention is installed is a conventional four-cylinder engine, for example. The engine includes a cylinder block (not shown) and a Cylinder head 19 (shown in FIG. 2) in which an intake port 23 corresponding to each cylinder is formed. Outside air cleaned by an air cleaner is introduced into each cylinder of the engine through the air-intake device. Fuel injected into the intake port 23 from an injector (not shown) is mixed with the air introduced through the air-intake device. Air-fuel mixture is burnt in the cylinder by igniting it by a spark plug to thereby drive a piston in the cylinder. The injector, intake and exhaust valves and air-intake valves 3 of the air-intake device are electronically controlled by an on-board electronic control unit (ECU).

An amount of air supplied to the engine is controlled by changing an opening degree of the valves 3 in the air-intake device. Four valves (valve plates) 3, each corresponding to each cylinder, are installed in the casing 1, as shown in FIGS. 1 and 2. The four valves 3 are simultaneously controlled by a single shaft 7 that is connected to all of the four valves 3. Intake air swirls such as a circular flow or a tumble flow are generated in each cylinder by squeezing air passages 21, 22 in the casing 1 by the valves 3 (refer to FIG. 2). A surge tank for reducing pulsating pressure in the intake air and other associated components are connected to the air-intake device. The surge tank, the casing 1 and other associated components are all made of a synthetic resin material.

As shown in FIG. 2, a valve unit is composed of the cartridge 2, the valve 3 and the spacer 4. Each valve unit is disposed in a space 24 for accommodating the valve unit in the casing 1 (refer to FIG. 1). A Shaft hole 34 for fixedly inserting the shaft 7 is formed through the valve axis 35, and the valve axis 35 is rotatably supported in both sidewalls of the cartridge 2 via bearings 5. The through-hole 34 has a square (or any another polygonal cross-section) corresponding to the cross-section of the middle portion 42 of the shaft 7. The air passages 21 and 22 are formed in the casing 1, and intake port 23 is formed in the cylinder head 19. The air passages 21, 22 and the intake port 23 are aligned in this order along the intake airflow. The intake port 23 is connected to each cylinder.

A space 26 for accommodating valve 3 therein is formed above the spacer 4 so that the valve 3 is not exposed in the air passage 22 when the valve 3 is fully opened. The spacer 4 functions to eliminate a step 27 between the cylinder head 19 and the cartridge 2 to prevent a large amount of fuel from staying at the bottom portion of the cartridge 2 and form being supplied to the combustion chamber of the engine at once. In this manner, it is avoided that an air-fuel ratio in the cylinder becomes over-rich, causing incomplete combustion and resulting in bad emission.

All the valves 3 are commonly driven by rotating the shaft 7 by an electric motor, and an opening degree of each valve is controlled from a fully closed position to a fully open position. The valves 3 are brought to the fully closed position when the engine is cold or a little intake air is required. The valves 3 come to the fully closed position when a stopper lever 33 (refer to FIG. 1) connected to the joint-shaft 31 abuts a stopper member (not shown). The valves 3 are brought to the fully open position when the engine is driven at intermediate or high speed or under an intermediate or heavy load. The valves 3 come to the fully open position when the stopper lever 33 abuts another stopper member (not shown). The valves are returned to the initial position (the fully open position or a position slightly closed from the fully open position) by a biasing force such as a spring force upon termination of power supply to the motor when the engine is stopped.

As shown in FIG. 2, each valve 3 is connected to the shaft 7 at its one end so that it pivotally moves around the one end. Accordingly, the valve 3 can be fully accommodated in the space 26 when it comes to the fully closed position not to interfere with the airflow through the air massages 21, 22, 23. A cutoff portion 36 is formed at a free end of the valve 3. The cutoff portion 36 serves to form swirl flow (tumble flow) in the intake air supplied to the combustion chamber of the engine. The cutoff portion 36 shown in FIG. 1 may be modified to another form. For example, free end corners of the valve 3 may be cut off, forming smaller openings than the cutoff portion 36. Alternatively, it is not absolutely necessary to form such a cutoff portion or openings. The casing 1, cartridges 2 and valves 3 are all made of a synthetic resin material such as polyamide.

The shaft 7 is made of steel and includes a middle portion 42 having a square cross-section (or a polygonal cross-section), an end portion 41 (the right side end in FIG. 1), and another end portion 43 (the left side end in FIG. 1). A joint-shaft 31 is connected to the shaft 7 at a position close to the left end portion 43. The joint-shaft having a round outer periphery is rotatably supported in a bearing-supporting portion 16 of the casing 1 via a ball bearing 14. An oil seal 15 is disposed at a right side of the ball bearing 14. The stopper lever 33 is connected to the joint-shaft 31 by a nut 37, and a lever 39 for mounting a magnet rotor 48 thereon is connected to the left end portion 43 by a nut 38.

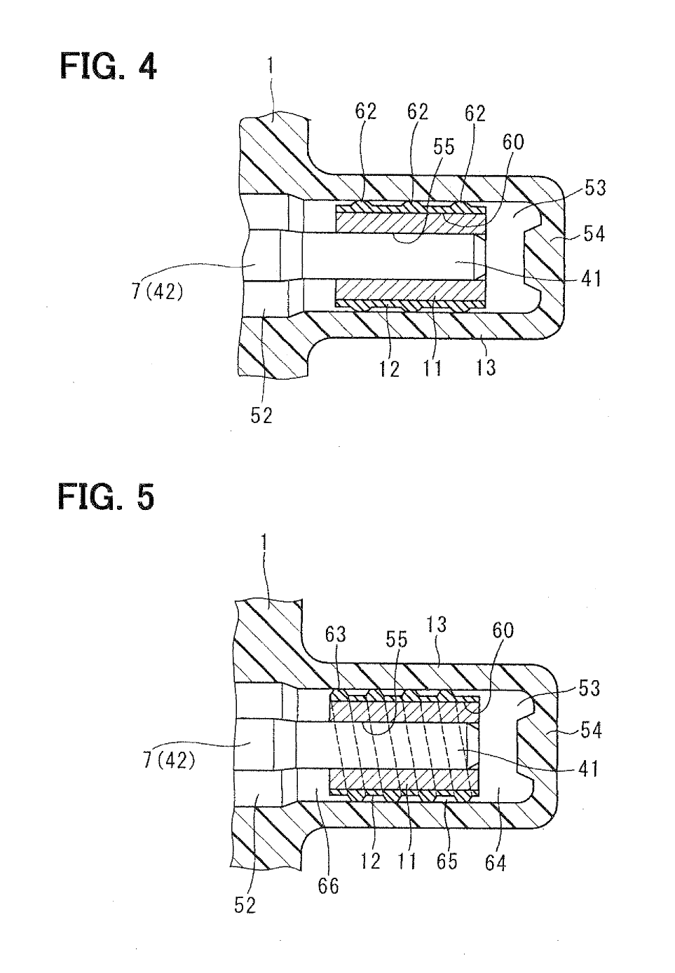

As shown in FIG. 4, the end portion 41 having a round outer periphery is rotatably supported in a bearing-supporting portion 13 of the casing 1 via a bearing device composed of a bearing 11 and a rubber bushing 12. The bearing device will be described later in detail.

The actuator 44 for driving the shaft 7 is connected to the casing 1. The actuator 44 includes an electric motor and speed-reduction gear having a final gear 32 connected to the shaft 7. The final gear 32 is made of a synthetic resin material in an arc-shape, and the stopper lever 33 is insert-molded in the final gear 32. A bent portion 45 abuts a fully open stopper (not shown) when the valves 3 are driven to the fully open position, while it abuts a fully closed stopper (not shown) when the valves 3 are driven to the fully closed position to thereby restrict rotation of the final gear 32. The electric motor in the actuator 44 is controlled by the on-board electronic control unit (ECU). The ECU includes a known microcomputer having memory devices (ROM, RAM), I/O and a power source. Upon turning on the ECU, it controls operation of the electric motor for driving the shaft 7 according to a control program or a control logic stored in the memory while controlling other components such as fuel injectors, a fuel pump and an ignition device. The opening degree of the valves 3, i.e., an amount of the intake air supplied to the engine is controlled according to operating conditions of the engine. Upon turning off an ignition switch, the ECU is turned off. The valves 3 are automatically brought to the fully open position or a position where the valves 3 are slightly closed by means of the electric motor or a biasing spring.

Various electric signals are fed to the ECU from on-board sensors such as a crank angle sensor, an accelerator sensor, a sensor for detecting opening degrees of the valve, a temperature sensor for cooling water, an airflow meter and an exhaust gas sensor. The sensor for detecting an opening degree of the valves 3 is composed of the magnet rotor 48 and a stator including a Hall IC 47 (refer to FIG. 1). A permanent magnet 46 is molded in the magnet rotor 48, and the lever 39 is insert-molded. Since the magnet rotor 48 rotates together with the shaft 7, an amount of magnetic flux supplied to the Hall IC 47 varies according to rotation of the magnet rotor 48. Thus, the opening degree of the valves 3 is detected by the sensor. An electric magnet may be used in place of the permanent magnet 46. The magnet rotor 48 may be mounted on the stopper lever 33 in place of the lever 39.

Now, referring to FIG. 4, the bearing device supporting the end portion 41 of the shaft 7 will be described in detail. This bearing structure is a so-called floating bearing structure. The shaft 7 extends through holes 52 formed in the walls 51 separating each space 24 for accommodating the cartridge 2. The casing 1 includes a bearing-supporting portion 13 providing a space 53 for disposing the bearing device. The air passage 22 formed in the cartridge 2 is hermetically connected to the intake port 23 of each cylinder (refer to FIG. 2). The space 53 is closed with a closed end 54, and the shaft end 41 extends into the space 53. An inner bore 55 of a bearing 11 is slidably coupled to the round outer periphery of the end portion 41. A resilient rubber bushing 12 is disposed between the bearing 11 and an inner bore of the bearing-supporting portion 13. The bearing 11 is made of a metallic material such as sintered metal.

The rubber bushing 12 is made of a resilient rubber material having a high durability against low and high temperature, and a high durability against oil, such as fluorine rubber. The rubber bushing 12 has an inner bore 60 which is firmly connected to the outer periphery of the bearing 11 by baking or the like. Circular ribs 62 projected from the rubber bushing 12 are formed on its outer surface, so that the circular ribs 62 are compressed between the inner bore of the bearing-supporting portion 13 and the bearing 11. A cross-section of the circular rib 62 is formed in a half circle shape, a polygonal shape or the like. In this particular embodiment, three circular ribs 62 are formed at certain intervals therebetween. By the resiliency of the rubber bushing 12, the end portion 41 of the shaft can be correctly positioned in the space 53 even if there is a certain eccentricity between the axis of the end portion 41 and an axial centerline of the bearing-supporting portion 13.

Operation of the air-intake device of the present invention described above will be briefly explained. Upon turning on the ignition switch, the actuator 44 for driving the shaft 7 is controlled by the ECU. In an intake stroke of a cylinder of the engine, the intake air is supplied to the combustion chamber together with fuel injected through the air passages 21, 22 and the intake port 23. Since the engine is operated under four strokes, an intake stroke, a compression stroke, an expansion stroke (a combustion stroke) and an exhaust stroke, intake pulsations are generated in the intake port 23.

When a large amount of intake air is required, the valves 3 are fully opened by the actuator 44. The stopper lever 33 (refer to FIG. 1) is rotated until it abuts a full open stopper. The intake air passing through the intake port 23 is supplied to the combustion chamber. In this situation, no swirl flow (tumble flow) is not generated in the cylinder. When a small amount of intake air is required, the valves 3 are driven toward the fully closed position. The stopper lever 33 is rotated until it abuts a full close stopper. When the valves 3 are at the fully closed position, intake air flowing through the cutout portion 36 of the valve 3 is supplied to the combustion chamber, flowing through along an upper wall of the intake port 23. Under this situation, the tumble flow is generated in the cylinder. Because of the tumble flow, combustion efficiency in the combustion chamber is improved when the engine is being started or idling. Fuel economy and exhaust emission (such as HC) are improved.

Advantages attained in the first embodiment described above will be summarized below. The end portion 41 of the shaft 7 is rotatably supported in the bearing-supporting portion 13 of the casing 1 via the bearing device. The bearing device is composed of the bearing 11 rotatably coupled to the end portion 41 and the rubber bushing 12 resiliently compressed between the inner bore of the bearing-supporting portion 13 and the bearing 11. The rubber bushing 12 is connected to the outer periphery of the bearing 11 by baking or the like. The end portion 41 of the shaft 7 is resiliently supported in the bearing-supporting portion 13. A certain eccentricity of the end portion 41 relative to the casing 1 due to dimensional deviations of the components is absorbed by the resiliency of the rubber bushing 12. Therefore, the shaft 7, the bearing 11 and the rubber bushing 12 are easily assembled to the bearing-supporting portion 13 of the casing 1, resulting in improvement of the assembly process.

Vibrations of the shaft end 41 due to the intake air pulsation caused by strokes of the engine are absorbed by the resiliency of the rubber bushing 12. Therefore, hitting noises between the end portion 41 and the bearing-supporting portion 13 are suppressed. Clearances in the radial direction among the end portion 41, the bearing 11 and the inner bore of the bearing-supporting portion 13 may change according to temperature changes. Such clearance changes are absorbed by the resiliency of the rubber bushing 12, suppressing increase in the sliding torque between the shaft end 41 and the bearing 11. Therefore, the shaft 7 smoothly rotates, and smooth movements of the valves are ascertained.

Since the circular ribs 62 are compressed between the inner bore of the bearing-supporting portion 13 and the bearing 11, movement of the rubber bushing 12 and the bearing 11 in the axial direction is suppressed. The circular ribs 62 (three ribs in this particular embodiment) made of a material having a high sealing ability such as fluorine rubber are disposed. Therefore, the circular ribs 62 located at the axial outside of the rubber bushing 12 prevents grease or oil lubricating the end portion 41 from entering into a middle portion of the rubber bushing 12. Thus, the middle circular rib 62 is kept dry (kept free from the lubricant), and the friction between the rubber bushing 12 and the inner bore of the bearing-supporting portion 13 in the axial direction is maintained.

A second embodiment of the present invention is shown in FIG. 5. In this embodiment, a continuous spiral rib 63 is formed on the outer surface of the rubber bushing 12. A spiral groove 65 is formed between the spiral rib 63. An axial end space 64 at the right side of the bearing 11 and an axial end space 66 at the left side of the bearing 11 communicate with each other through the spiral groove 65. The axial end space 66 communicates with the air passages 22 through the holes 52 of the casing 1. Other structures and functions are the same as those in the first embodiment.

Since the axial end space 64 at the right side communicates with the axial end space 66 at the left side through the spiral groove 65, the pressures in both of the axial end spaces 64, 66 become equal even when a negative pressure in the air passage 22 is introduced into the axial end space 66 according to strokes of the engine. Therefore, shifting of the bearing 11 and the rubber bushing 12 in the axial direction is suppressed. Further, such shifting due to pressure increase in the axial end space 64 according to a temperature rise is suppressed.

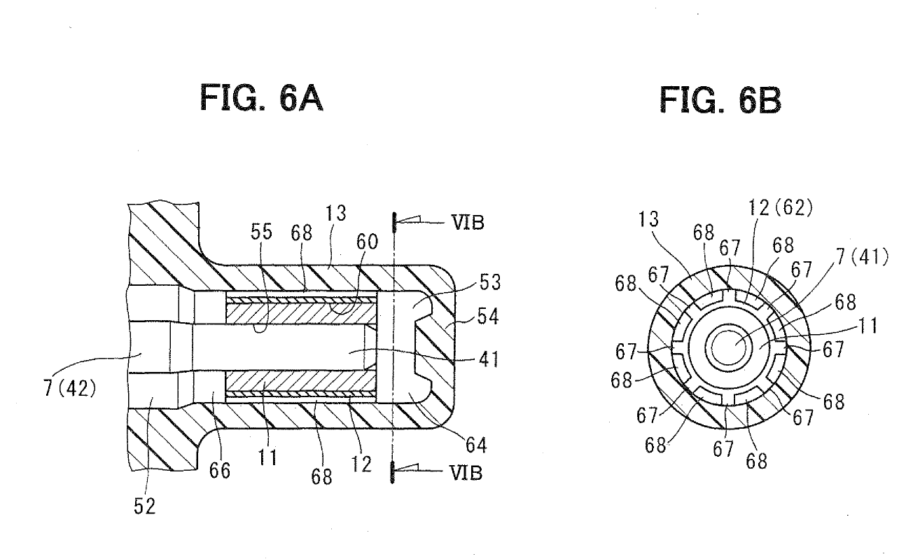

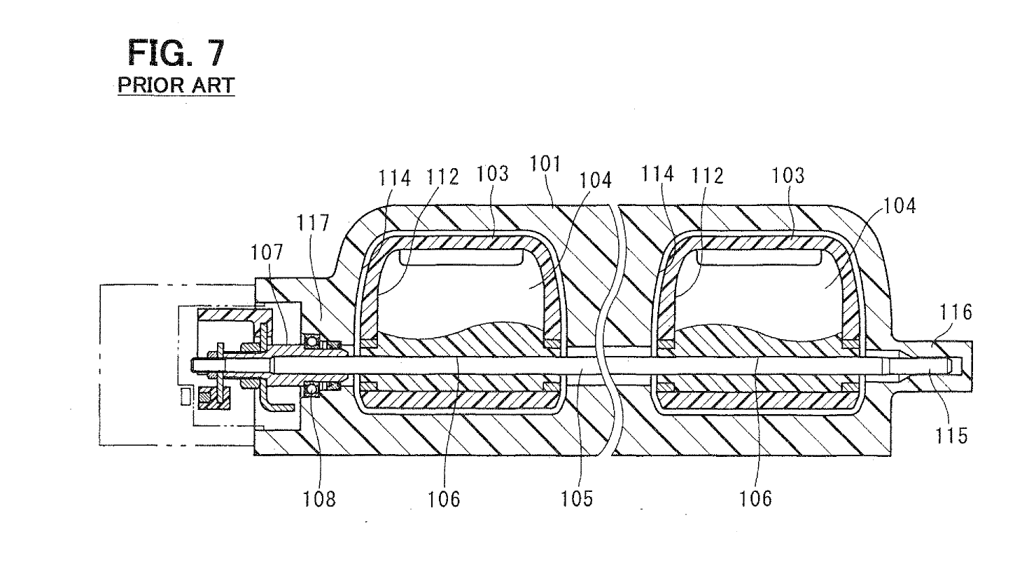

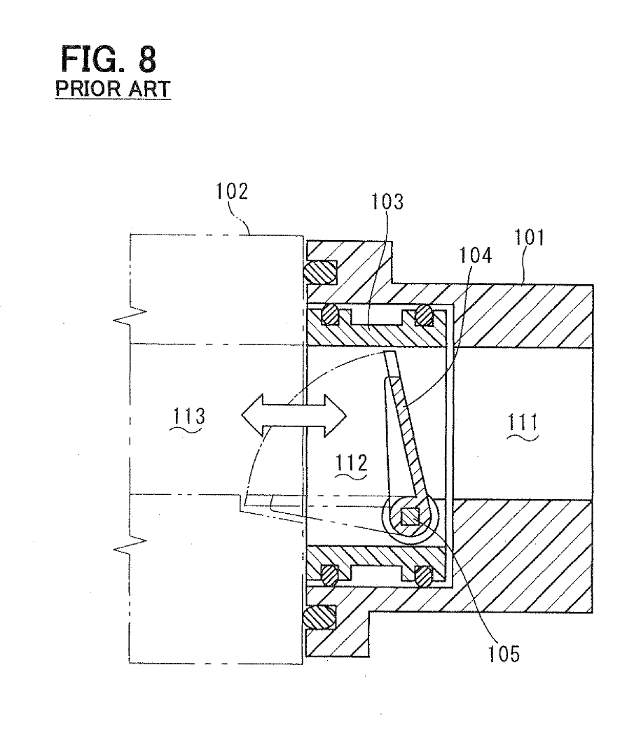

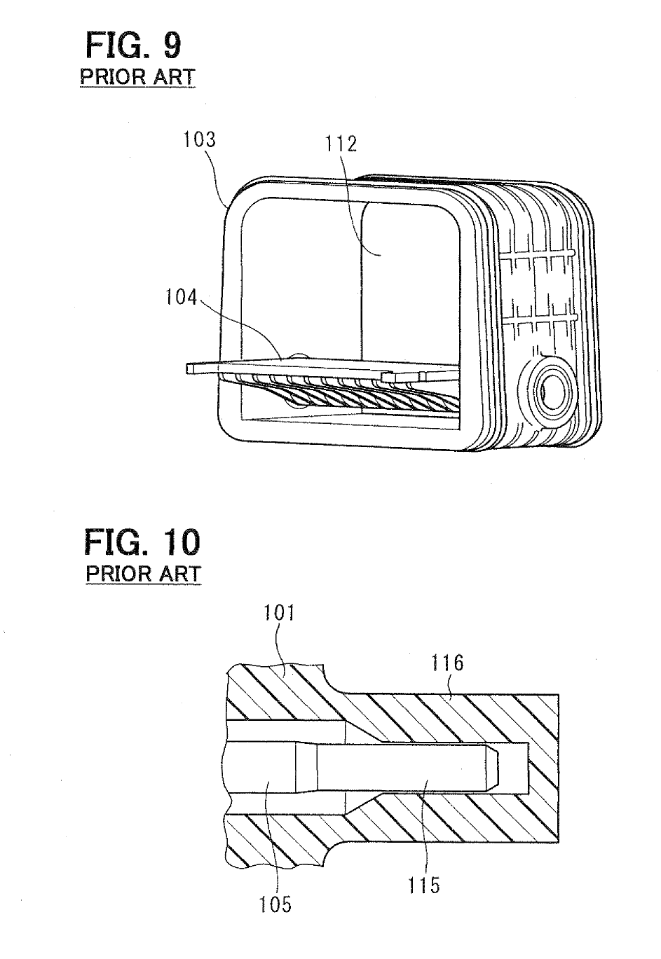

A third embodiment of the present invention is shown in FIGS. 6A and 6B. In this embodiment, ribs 67 projected from the outer surface of the rubber bushing 12 extend in the axial direction of the rubber bushing 12. Elongated passages 68 are formed between the neighboring projected ribs 67. The elongated passages 67 connect both axial end spaces 64 and 66 so that air in both spaces communicates. The projected ribs 67 are compressed between the inner bore of the bearing-supporting portion 13 and the bearing 11. Other structures and functions are the same as those of the foregoing embodiments. Since the both axial end spaces 64 and 66 communicate with each other, the same advantages attained in the second embodiment are attained in this embodiment, too.

The present invention is not limited to the embodiments described above, but it may be variously modified. For example, though the above-embodiments are structured to generate the intake tumble flows in a longitudinal direction in the combustion chamber, the air-intake device may be structured to generate swirl flows in a lateral direction or squish flows to promote combustion in the combustion chamber. Though the present invention is applied to the air-intake device, it may be applied to other devices such as an electronic throttle device or a device for changing a length or a cross-section of an intake air passage. Though the shaft 7 connected to the valves 3 is driven by the actuator 44 having an electric motor and a speed reduction gears in the foregoing embodiments, it is also possible to drive the shaft directly by an electric motor. A biasing member such as a spring may be used for biasing the valves 3 in a direction to close or in a direction to open.

An intake air amount control valve having a throttle valve or a control valve having an idle speed control valve that controls an amount of air bypassing a throttle valve may be used in place of the valve unit used in the foregoing embodiments. A valve for opening or closing an intake air passage, a valve for switching intake air passages or a valve for controlling an intake air pressure may be used in place of the valves used in the embodiments of the present invention. The intake air control valve may be applied to an intake air flow control valve such as a tumble flow control valve or a swirl flow control valve, or an intake air passage control valve that changes a length or a cross-section of an intake air passage. The internal combustion engine in which the air-intake valve of the present invention is used is not limited to the gasoline engine. It may be used in a diesel engine or in a single cylinder engine.

The valve 3 is disposed in each cartridge 2 and all valves are driven by the common shaft 7 in the foregoing embodiments. However, the valves may be directly disposed in the casing and directly driven by the common shaft. In this case, the cartridge 2 can be eliminated. Though the so-called floating bearing structure is used only at one end 41 of the shaft 7 in the foregoing embodiments, it is possible to use the floating bearing structure at both ends of the shaft. Though the rubber bushing 12 is connected to the bearing 11 by baking in the foregoing embodiments, it is possible to connect the rubber bushing to the bearing with adhesive or by staking. It may be also possible to fix the rubber bushing to the bearing with a band. Though the bearing-supporting portions 13, 16 are integrally formed with the casing 1 in the foregoing embodiments, it is possible to connect the separately formed bearing-supporting portions to the casing. The bearing 11 (a sleeve bearing) is used in the foregoing embodiments, other bearings such as a ball bearing may be used in place of the sleeve bearing.

While the present invention has been shown and described with reference to the foregoing preferred embodiments, it will be apparent to those skilled in the art that changes in form and detail may be made therein without departing from the scope of the invention as defined in the appended claims.

What is claimed is:

1. An air-intake device for an internal combustion engine, the air-intake device having a plurality of air passages each connected to each cylinder of the internal combustion engine, the air-intake device comprising:
a casing having a plurality of air passages formed therein;
a plurality of valves each disposed in each air passage of the casing for controlling an amount of intake air passing therethrough;
a shaft connected to each valve to simultaneously control an opening degree of each valve; and
a bearing device disposed in a bearing-supporting portion formed in the casing, the bearing device being composed of a bearing rotatably supporting one end of the shaft in the casing and a rubber bushing, disposed between the bearing and the bearing-supporting portion, for resiliently supporting the shaft in the casing.

2. The air-intake device as in claim 1, wherein the rubber bushing includes projected portions formed on its outer periphery, the projected portions being in close contact with an inner periphery of the bearing-supporting portion.

3. The air-intake device as in claim 2, wherein the projected portions are formed as a plurality of circular ribs surrounding the outer periphery of the rubber bushing with a certain space apart from one another in an axial direction of the rubber bushing.

4. The air-intake device as in claim 2, wherein the projected portions are formed as a spiral rib surrounding the outer periphery of the rubber bushing, and a spiral groove is formed between neighboring lines of the spiral rib so that spaces at both axial ends of the rubber bushing in the bearing-supporting portion communicate through the spiral groove.

5. The air-intake device as in claim 2, wherein the projected portions are formed as a plurality of projected ribs projected in a radial direction and elongated in an axial direction of the rubber bushing, and the projected ribs are formed with a certain space apart from one another in a circumferential direction of the rubber bushing.

6. The air-intake device as in claim 5, wherein a plurality of elongated passages are formed between the projected ribs so that spaces at both axial ends of the rubber bushing in the bearing-supporting portion communicate through the elongated passages.

7. The air-intake device as in claim 1, wherein the bearing device is disposed at least one axial end portion of the shaft.

8. The air-intake device as in claim 1, wherein the shaft connected to each valve extends in the direction perpendicular to air passages in the casing.

9. The air-intake device as in claim 1, wherein each valve is supported in a cartridge that is held in each air passage in the casing.
